(19) United States
(12) Patent Application Publication
(10) Pub. No.: US 2026/0024553 A1
(43) Pub. Date: Jan. 22, 2026

(54) DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Takuya KOBAYASHI, Kawasaki Kanagawa (JP)

(21) Appl. No.: 19/044,259

(22) Filed: Feb. 3, 2025

(30) Foreign Application Priority Data
Jul. 19, 2024 (JP) 2024-115853

(51) Int. Cl. G11B 20/18; G11B 20/10; G11B 20/12

(52) U.S. Cl. CPC G11B 20/1833; G11B 20/10388; G11B 20/1217; G11B 2020/1222

(57) ABSTRACT

According to one embodiment, in a disk device, a disk medium has a recording surface configured to face the head, the disk medium being medium where multiple tracks defined on the recording surface, each of the multiple tracks including multiple sectors. A controller is configured to perform error correction for each of the sectors on a per track basis. The controller is configured to predict, while writing data to a first track of the multiple tracks by a head, that the number of error sectors of a second track adjacent to the first track reaches a correction limit number of sectors, according to a track margin identified by first management information and an off-track amount of the first track. The controller is configured to update the first management information according to a bit error rate reference value and a bit error rate of information read from a track.

### CROSS-REFERENCE TO RELATED APPLICATIONS

This application is based upon and claims the benefit of priority from Japanese Patent Application No. 2024-115853, filed on Jul. 19, 2024; the entire contents of which are incorporated herein by reference.

### FIELD

Embodiments described herein relate generally to a disk device.

### BACKGROUND

In a disk device having a disk medium in which multiple tracks each including multiple sectors is defined, error correction for each of the sectors is performed for the disk medium on a per track basis, in some cases. In the disk device, it is desirable to appropriately perform error correction.

### BRIEF DESCRIPTION OF THE DRAWINGS

FIG. 1 is a diagram illustrating a configuration of a disk device according to an embodiment;

FIG. 2 is a diagram illustrating a configuration of disk mediums and heads according to an embodiment;

FIG. 3 is a diagram illustrating a configuration of the disk medium according to an embodiment;

FIG. 4 is a diagram illustrating a configuration of a track according to an embodiment;

FIG. 5 is a graph illustrating a configuration of update management information according to an embodiment;

FIG. 6 is a table illustrating a configuration of reference bit error rate management information according to an embodiment;

FIG. 7 is a table illustrating a configuration of track margin management information (before update) according to an embodiment;

FIG. 8 is a flowchart illustrating a bit error rate testing process according to an embodiment;

FIG. 9 is a table illustrating a configuration of the track margin management information (after update) according to an embodiment;

FIG. 10 is a diagram illustrating a configuration of a disk medium according to a first modification of the embodiment;

FIG. 11 is a table illustrating a configuration of reference bit error rate management information according to the first modification of the embodiment;

FIG. 12 is a table illustrating a configuration of track margin management information (before update) according to the first modification of the embodiment;

FIG. 13 is a table illustrating a configuration of the track margin management information (after update) according to the first modification of the embodiment; and

FIG. 14 is a flowchart illustrating an operation of the disk device according to a second modification of the embodiment.

### DETAILED DESCRIPTION

In general, according to one embodiment, there is provided a disk device including a head, a disk medium and a controller. The disk medium has a recording surface configured to face the head, the disk medium being medium where multiple tracks defined on the recording surface, each of the multiple tracks including multiple sectors. The controller is configured to perform error correction for each of the sectors on a per track basis. The controller is configured to predict, while writing data to a first track of the multiple tracks by the head, that the number of error sectors of a second track adjacent to the first track reaches a correction limit number of sectors, according to a track margin identified by first management information and an off-track amount of the first track. The controller is configured to update the first management information according to a bit error rate reference value and a bit error rate of information read from a track.

Exemplary embodiments of a disk device will be explained below in detail with reference to the accompanying drawings. The present invention is not limited to the following embodiments.

### EMBODIMENTS

The disk device according to an embodiment includes the disk medium in which the multiple tracks each including the multiple sectors is defined, and error correction is performed for the disk medium for each of the sectors on a per track basis, where the error correction is devised appropriately.

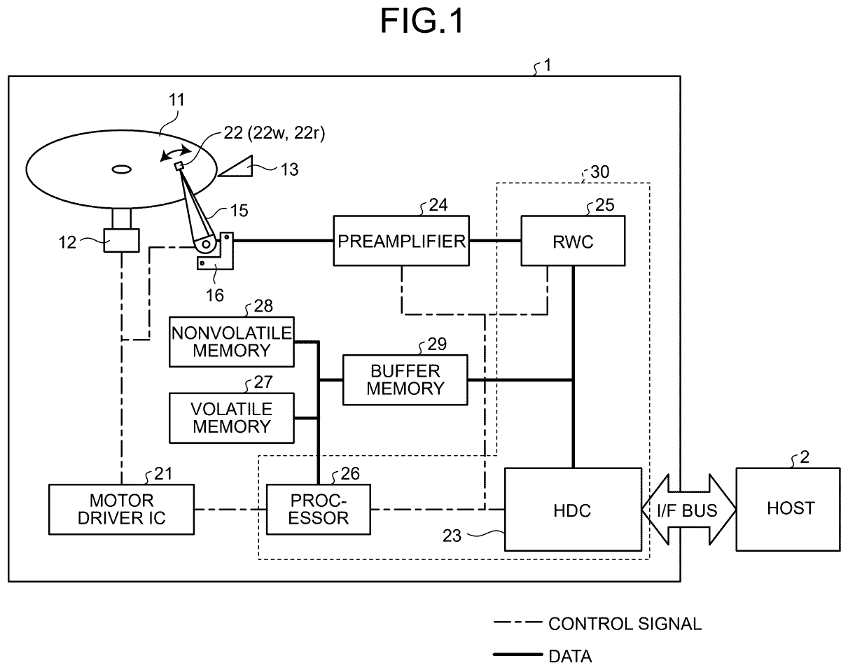

A disk device 1 can be configured as illustrated in FIG. 1. FIG. 1 is a diagram illustrating a configuration of the disk device 1.

The disk device 1 is configured to be connected to a host 2 via a communication medium. The disk device 1 is connected to the host 2 and configured to function as a storage medium for the host 2. The disk device 1 is configured to receive an access command from the host 2. The access command includes a write command and a read command.

The disk device 1 includes a disk medium 11, a spindle motor (SPM) 12, a ramp 13, an actuator arm 15, a voice coil motor (VCM) 16, a driver 21, a head 22, a preamplifier 24, a controller 30, a volatile memory 27, a nonvolatile memory 28, and a buffer memory 29.

The controller 30 enables integral control of the units of the disk device 1. The controller 30 includes a hard disk controller (HDC) 23, a read/write channel (RWC) 25, and a processor 26. The controller 30 can be constituted by a system-on-chip (SoC).

The disk medium 11 is a disk-type storage medium, and may be, for example, a magnetic disk or a magneto-optical disk. When the disk medium 11 is the magnetic disk, magnetic layer is formed on a surface thereof, and information is recordable according to a magnetization direction.

The SPM 12 rotatably supports the disk medium 11 in a housing (not illustrated) of the disk device 1.

The driver 21 is configured to drive the SPM 12 and the VCM 16 under the control of the processor 26. The driver 21 can be constituted by an integrated circuit (IC).

The head 22 is configured to face the recording surface of the disk medium 11. The head 22 writes or reads data to or from the disk medium 11 by using a write element 22w and a read element 22r that are provided at the head 22. Furthermore, the head 22 is mounted to an end of the actuator arm 15. The head 22 is moved for seeking in a radial direction of the disk medium 11 by the VCM 16 driven by the driver 21.

For example, when the rotation of the disk medium 11 is stopped, the head 22 is moved onto the ramp 13. The ramp 13 is configured to hold the head 22 at a position separated from the disk medium 11.

The preamplifier 24 amplifies a signal read from the disk medium 11 by the head 22, outputs the amplified signal, and supplies the output signal to the RWC 25, upon reading. In addition, the preamplifier 24 amplifies a signal corresponding to data supplied from the RWC 25 and supplies the amplified signal to the head 22, upon writing. The preamplifier 24 can be constituted by an integrated circuit (IC).

The RWC 25 performs modulation including error correction coding on data supplied from the HDC 23 and supplies the modulated data to the preamplifier 24. In addition, the RWC 25 performs demodulation including error correction decoding on the signal read from the disk medium 11 and supplied from the preamplifier 24, and outputs the signal to the HDC 23 as digital data.

The error correction coding performed by the RWC 25 includes generation of a parity for track ECC. The error correction performed by the RWC 25 includes the track ECC. The track ECC will be described later.

The HDC 23 performs control of transmission and reception of data to and from the host 2 via the I/F bus, control of the buffer memory 29, and the like.

Furthermore, the buffer memory 29 is used as a buffer for data transmitted to and received from the host 2. The buffer memory 29 is constituted by, for example, a volatile memory capable of high-speed operation. The type of the memory constituting the buffer memory 29 is not limited to a specific type. The buffer memory 29 can be constituted by, for example, a dynamic random access memory (DRAM), a static random access memory (SRAM), or a combination thereof.

The processor 26 is, for example, a central processing unit (CPU). The volatile memory 27, the nonvolatile memory (flash read only memory) 28, and the buffer memory 29 are connected to the processor 26.

The nonvolatile memory 28 stores firmware (program data), various operation parameters, and the like. In addition, the nonvolatile memory 28 is used as an emergency storage destination for various information in the volatile memory 27 when power supply is stopped. Note that part or all of the firmware may be stored in the disk medium 11.

The volatile memory 27 is constituted by, for example, DRAM, SRAM, or a combination thereof. The volatile memory 27 is used by the processor 26, as an area into which the firmware is loaded or an area in which various management information is cached or buffered.

The processor 26 loads the firmware from the nonvolatile memory 28 into the volatile memory 27 to execute control of the driver 21, the preamplifier 24, the RWC 25, the HDC 23, and the like according to the loaded firmware. The processor 26 uses, upon control, various management information cached or buffered in the volatile memory 27.

Note that a configuration including the RWC 25, the processor 26, and the HDC23 can be considered as the controller 30. In addition to these components, the controller 30 may include another component (e.g., the volatile memory 27, the nonvolatile memory 28, the buffer memory 29, or the like).

Some or all of the functions of the controller 30 may be implemented by a hardware circuit such as a field-programmable gate array (FPGA) or an application specific integrated circuit (ASIC). Some or all of the functions of the controller 30 may be implemented by executing the firmware by the processor 26.

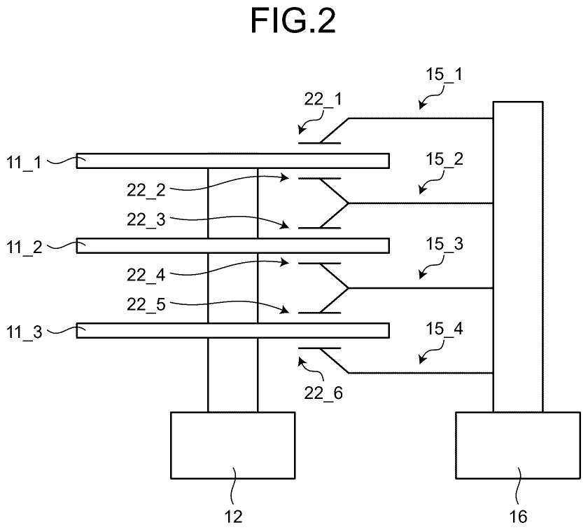

As illustrated in FIG. 2, the disk device 1 may include multiple disk media 11_1 to 11_3, multiple actuator arms 15_1 to 15_4, and multiple heads 22_1 to 22_6. FIG. 2 is a diagram illustrating a configuration of the disk media 11_1 to 11_3 and the heads 22_1 to 22_6. FIG. 2 illustrates the configuration of the disk media 11_1 to 11_3 and the heads 22_1 to 22_6, with the disk media 11_1 to 11_3 viewed from a side along the recording surface.

The multiple disk media 11_1 to 11_3 are arranged to be spaced apart along a shaft of the SPM 12 and is rotatably supported by the shaft of the SPM 12. The multiple actuator arms 15_1 to 15_4 are arranged spaced apart along a shaft of the VCM 16 and is rotatably supported by the shaft of the VCM 16. The actuator arms 15_1, 15_2, 15_3, and 15_4 is configured to move for seeking in the radial direction, above the disk medium 11_1, between the disk media 11_2 and 11_3, between the disk media 11_3 and 11_4, and below the disk medium 11_4, respectively.

The head 22_1 is provided at an end on a lower side of the actuator arm 15_1 so as to face a recording surface on an upper side of the disk medium 11_1. The head 22_2 is provided at an end on an upper side of the actuator arm 15_2 so as to face a recording surface on a lower side of the disk medium 11_1. The head 22_3 is provided an end on a lower side of the actuator arm 15_2 so as to face a recording surface on an upper side of the disk medium 11_2. The head 22_4 is provided at an end on an upper side of the actuator arm 15_3 so as to face a recording surface on a lower side of the disk medium 11_2. The head 22_5 is provided an end on a lower side of the actuator arm 15_3 so as to face a recording surface on an upper side of the disk medium 11_3. The head 22_6 is provided at an end on an upper side the actuator arm 15_1 and so as to face a recording surface on a lower side of the disk medium 11_3.

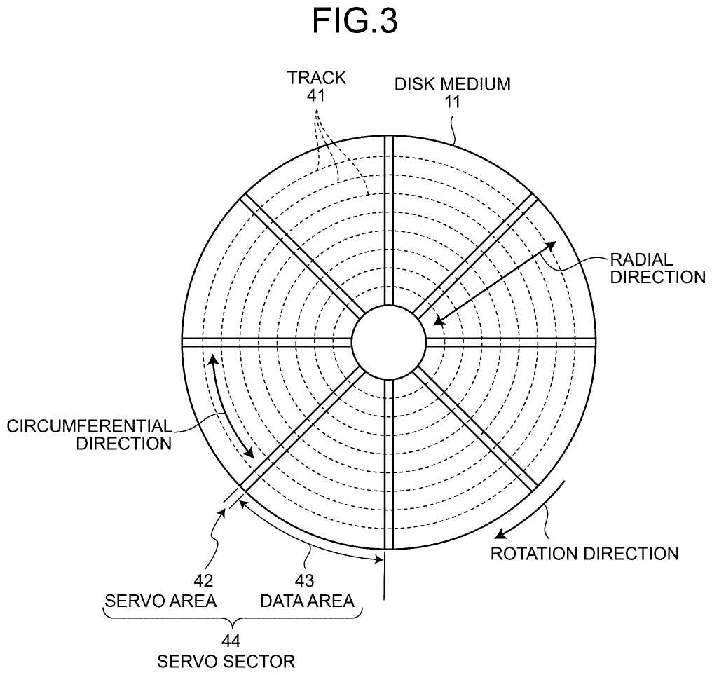

Each of the disk media 11 can be configured as illustrated in FIG. 3. FIG. 3 is a diagram illustrating a configuration of the disk medium 11.

Servo information is written on the disk medium 11 by, for example, a servo writer or self-servo write (SSW) in a manufacturing process. FIG. 3 illustrates servo areas 42 radially arranged, as an example of the arrangement of the servo areas in which the servo information is written.

The servo information includes sector/cylinder information, a burst pattern, a post code, and the like. The sector/cylinder information can give position information (servo sector address) in a circumferential direction of the disk medium 11 and position information (track number) of a track set in the radial direction. The track number obtained from the sector/cylinder information is an integer value indicating the position of a track, and the burst pattern represents an offset after the decimal point relative to the position indicated by the track number. The post code is a correction amount for correcting the distortion of the track set on the basis of a combination of the sector/cylinder information and the burst pattern.

The processor 26 and the driver 21 perform positioning control for the head 22, such as seeking and following, on the basis of the servo information read from a servo area 42.

Data areas 43 in which data can be written are provided between servo areas 42. One servo area 42 and one data area 43 subsequent to the servo area 42 constitute a servo sector 44. Multiple concentric tracks 41 are set in the radial direction of the disk medium 11.

In the data area 43, multiple sectors are provided along each of the tracks 41. Writing and reading by the head 22 are executed on a per sector basis. Each sector may have any storage capacity, but basically has a uniform storage capacity in the disk medium 11.

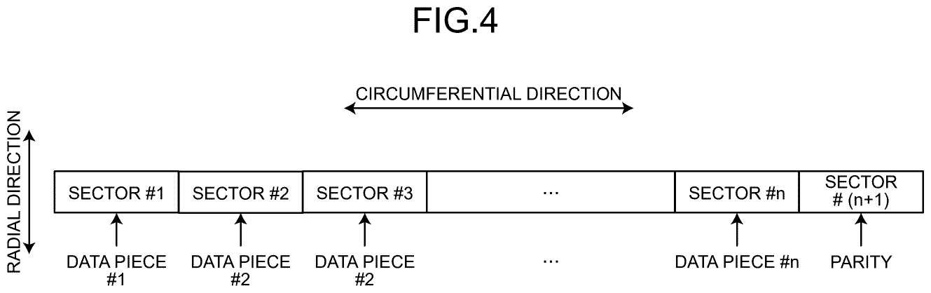

Each track 41 may have a configuration as illustrated in FIG. 4. FIG. 4 is a diagram illustrating a configuration of the track 41. In FIG. 4, the servo area 42 is not illustrated.

Each sector is identified by a sector number. A sector whose sector number is x is represented as a sector #x. In an example illustrated in FIG. 4, the track 41 includes (n+1) sectors from a sector #1 to a sector #(n+1).

The trailing sector of the (n+1) sectors, that is, the sector #(n+1) to which the largest sector number is given is set to a dedicated sector in which the parity is written. Data pieces #1 to #n having sizes corresponding to the respective sectors are written to n sectors #1 to #n, and the parity generated on the basis of the n data pieces #1 to #n written to the sectors #1 to #n is written to the sector #(n+1).

Therefore, when n data pieces are written to the sectors #1 to #n and the parity generated on the basis of the n data pieces is written to the sector #(n+1), the n data pieces written to the sectors #1 to #n are protected by the parity. In other words, even if read from any of the n sectors #1 to #n fails, error correction using the parity written to the sector #(n+1) enables acquisition of the data piece not containing an error. Note that the failure in reading means failure in acquiring the data piece not containing an error.

Hereinafter, a sector configured so that the parity such as the sector #(n+1) is written is referred to as a parity sector. Furthermore, a sector, such as each of the sectors #1 to #n, configured so that a data piece that can be a source of generation of the parity is written to is referred to as a data sector.

Error correction using the parity written to the parity sector is referred to as the track ECC. An error correction coding method for the track ECC, that is, a method of generating the parity is not limited to a specific method. In one example, the parity is generated by an XOR bit operation for all data pieces written to all data sectors.

In the track ECC, error correction for each sector is performed on a per track basis, but there is an upper limit of the number of sectors that can be corrected. This upper limit will be referred to as the correction limit in the number of sectors. When the number of error sectors exceeds the correction limit in the number of sectors before writing the last sector on a track, uncorrectable read error may occur at the track, leading to loss of data.

For this reason, the controller 30 may have a correction limit prediction function. The controller 30 predicts whether the number of error sectors reaches the correction limit in the number of sectors before writing the last sector on the track. The controller 30 is configured to predict the number of error sectors on an adjacent track according to the track margin and the off-track amount of the head 22, upon writing. When the off-track amount is within a range of the track margin, the controller 30 determines that a sector being written to is not an error sector. When the off-track amount is out of the range of the track margin, the controller 30 determines that the sector being written to is not the error sector. Therefore, the controller 30 can predict that the number of error sectors on the adjacent track reaches the correction limit in the number of sectors.

When the number of error sectors on the adjacent track does not reach the correction limit in the number of sectors, the controller 30 performs control to continue an off-track write. When the number of error sectors on the adjacent track reaches the correction limit in the number of sectors, the controller 30 prohibits subsequent off-track write and performs a write retry to another track.

In the disk device 1, characteristics may change over time. When the disk medium 11 is a magnetic disk, the bit error rate tends to increase even if the off-track amount is identical, as a holding force of the disk medium 11 deteriorates over time. In other words, in the disk device 1, as the bit error rate increases, the appropriate track margin tends have a stricter value.

For example, when the track margin is fixedly set, there is a possibility that accuracy in determination of the error sector decreases due to a change in characteristics over time, and accuracy in prediction of whether the number of error sectors reaches the correction limit in the number of sectors decreases, in the disk device 1.

Therefore, in the present embodiment, the controller 30 updates track margin management information according to the bit error rate reference value and the bit error rate of information read from a track, in the disk device 1, thereby improving accuracy in prediction of the correction limit, leading to prevention of the read error.

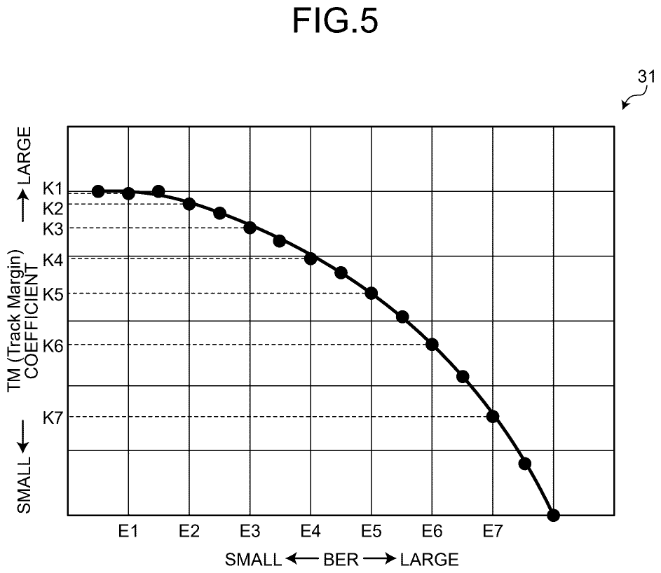

For example, the controller 30 may have update management information 31 as illustrated in FIG. 5. FIG. 5 is a graph illustrating a configuration of the update management information 31.

In the update management information 31, the bit error rate and the track margin are associated with each other, for multiple bit error rates. The update management information 31 may be implemented in the form of a table, or may be implemented in the form of a function. In FIG. 5, appropriate track margins are experimentally determined for multiple bit error rates, and a relationship between bit error rate and track margin is approximated by a function represented by a solid line. In FIG. 5, the vertical axis represents a track margin (TM) coefficient, and the horizontal axis represents the magnitude of the bit error rate (BER). The track margin coefficient is a coefficient for obtaining the track margin by being multiplied by an initial value TM0 of the track margin. The track margin coefficient can be regarded as information indicating the track margin.

Referring to the update management information 31 makes it possible to identify a value of an appropriate track margin coefficient to a bit error rate value. With reference to the update management information 31, when the bit error rate is “E1”, the appropriate track margin coefficient is identified as “K1”. When the bit error rate is “E2”, the appropriate track margin coefficient is identified as “K2”. When the bit error rate is “E3”, the appropriate track margin coefficient is identified as “K3”. When the bit error rate is “E4”, the appropriate track margin coefficient is identified as “K4”. When the bit error rate is “E5”, the appropriate track margin coefficient is identified as “K5”. When the bit error rate is “E6”, the appropriate track margin coefficient is identified as “K6”. When the bit error rate is “E7”, the appropriate track margin coefficient is identified as “K7”.

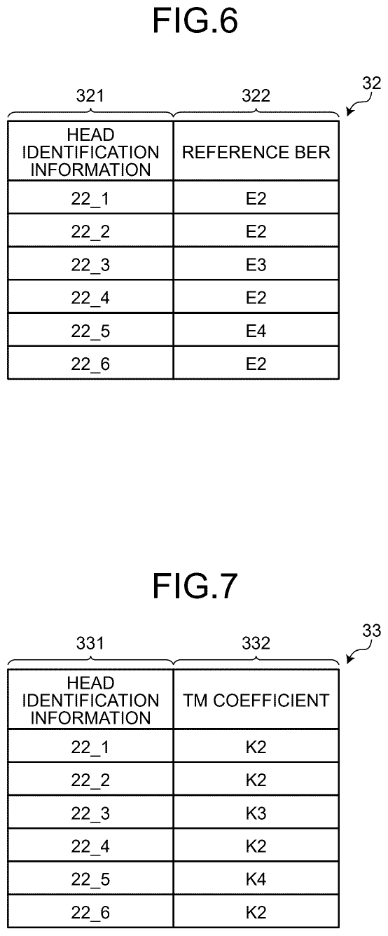

The controller 30 may have reference bit error rate management information 32 as illustrated in FIG. 6. FIG. 6 is a table illustrating a configuration of the reference bit error rate management information 32.

In the reference bit error rate management information 32, identification information for each head 22 and the bit error rate reference value are associated with each other, for the multiple heads 22. The reference bit error rate management information 32 may be implemented in the form of a table as illustrated in FIG. 6. The reference bit error rate management information 32 includes a head identification information column 311 and a reference BER column 312. In the head identification information column 311, identification information for the respective heads 22 is recorded. In the reference BER column 312, the bit error rate reference values are recorded. In the reference BER column 312, the bit error rate reference values may be recorded that are acquired upon testing before shipment of the disk device 1.

Referring to the reference bit error rate management information 32 makes it possible to identify the bit error rate reference value corresponding to the identification information for each head 22. For example, with reference to the reference bit error rate management information 32, the bit error rate reference value of the head “22_1” is identified as “E2”. The bit error rate reference value of the head “22_2” is identified as “E2”. The bit error rate reference value of the head “22_3” is identified as “E3”. The bit error rate reference value of the head “22_4” is identified as “E2”. The bit error rate reference value of the head “22_5” is identified as “E4”. The bit error rate reference value of the head “22_6” is identified as “E2”.

The controller 30 may create track margin management information 33 as illustrated in FIG. 7, according to the update management information 31 as illustrated in FIG. 5 and the reference bit error rate management information 32 as illustrated in FIG. 6. FIG. 7 is a table illustrating a configuration of the track margin management information 33 (before update).

In the track margin management information 33, the identification information for each head 22 and the track margin are associated with each other, for the multiple heads 22. The track margin management information 33 may be implemented in the form of a table as illustrated in FIG. 7. The track margin management information 33 includes a head identification information column 331 and a TM coefficient column 332. In the head identification information column 331, identification information for the respective heads 22 is recorded. In the TM coefficient column 332, values of the track margin coefficient are recorded. In the TM coefficient column 332, the values of the track margin coefficient may be recorded that are determined according to the update management information 31 as illustrated in FIG. 5 and the reference bit error rate management information 32 as illustrated in FIG. 6, upon testing before shipment of the disk device 1.

For example, according to the reference bit error rate management information 32, the bit error rate reference value of the head “22_1” is “E2”, and according to the update management information 31, when the bit error rate is “E2”, the appropriate track margin coefficient is “K2”. Therefore, in the track margin management information 33, “K2” is registered as the value of the track margin coefficient of the head “22_1”.

According to the reference bit error rate management information 32, the bit error rate reference value of the head “22_2” is “E2”, and according to the update management information 31, when the bit error rate is “E2”, the appropriate track margin coefficient is “K2”. Therefore, in the track margin management information 33, “K2” is registered as the value of the track margin coefficient of the head “22_2”.

According to the reference bit error rate management information 32, the bit error rate reference value of the head “22_3” is “E3”, and according to the update management information 31, when the bit error rate is “E3”, the appropriate track margin coefficient is “K3”. Therefore, in the track margin management information 33, “K3” is registered as the value of the track margin coefficient of the head “22_3”.

According to the reference bit error rate management information 32, the bit error rate reference value of the head “22_4” is “E2”, and according to the update management information 31, when the bit error rate is “E2”, the appropriate track margin coefficient is “K2”. Therefore, in the track margin management information 33, “K2” is registered as the value of the track margin coefficient of the head “22_4”.

According to the reference bit error rate management information 32, the bit error rate reference value of the head “22_5” is “E4”, and according to the update management information 31, when the bit error rate is “E4”, the appropriate track margin coefficient is “K4”. Therefore, in the track margin management information 33, “K4” is registered as the value of the track margin coefficient of the head “22_5”.

According to the reference bit error rate management information 32, the bit error rate reference value of the head “22_6” is “E2”, and according to the update management information 31, when the bit error rate is “E2”, the appropriate track margin coefficient is “K2”. Therefore, in the track margin management information 33, “K2” is registered as the value of the track margin coefficient of the head “22_6”.

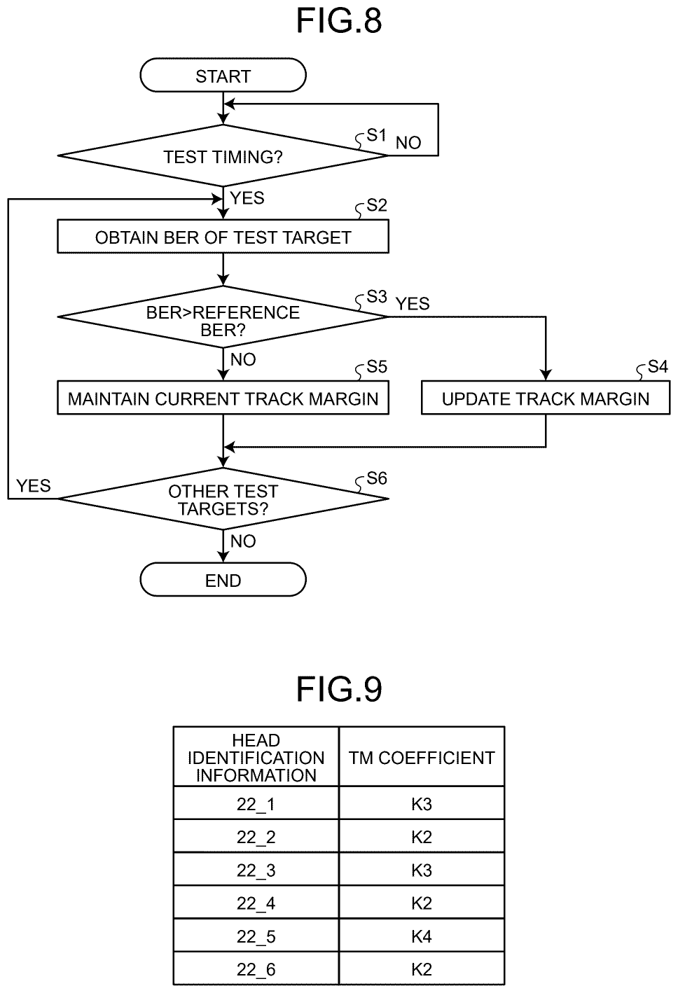

After shipment of the disk device 1, the controller 30 may perform a bit error rate testing process as illustrated in FIG. 8. FIG. 8 is a flowchart illustrating the bit error rate testing process.

The controller 30 waits until test timing (No in S1). The test timing may be the time of activation of the disk device 1, the time when a predetermined period has elapsed from the previous test, or the time when the disk device 1 is idle.

At the test timing (Yes in S1), the controller 30 selects a test target in terms of track margin management. When the track margin is managed for each head 22, the controller 30 selects a head 22 to be tested from the multiple heads 22_1 to 22_6.

The controller 30 reads information from the disk medium 11 by using the head 22 to be tested, and obtains the bit error rate (BER) of the head 22 to be tested by using a read signal (S2).

The controller 30 determines whether the bit error rate obtained in S2 exceeds the bit error rate reference value (reference BER) (S3).

When the bit error rate obtained in S2 exceeds the bit error rate reference value (Yes in S3), the controller 30 determines that the bit error rate degrades, and updates the track margin of the head 22 to be tested (S4).

For example, when the head 22 to be tested is the head 22_1, the bit error rate E3 exceeds the bit error rate reference value E2, if the bit error rate obtained in S2 is E3 (See FIGS. 5 and 6). Therefore, the controller 30 refers to the update management information 31 and identifies the track margin coefficient K3 corresponding to the bit error rate E3. The controller 30 accesses the track margin management information 33 as illustrated in FIG. 7 and updates the value of the TM coefficient column 332 corresponding to the head 22_1 to “K3” by overwriting, as illustrated in FIG. 9. FIG. 9 is a table illustrating a configuration of the track margin management information 33 (after update). As a result, the value of the track margin is updated from TM0×K2 to a stricter value TM0×K3.

When the bit error rate obtained in S2 is equal to or less than the bit error rate reference value (No in S3), the controller 30 determines that the bit error rate does not degrade, and maintains the current track margin (S5).

For example, when the head 22 to be tested is the head 22_1, the bit error rate E2 is equal to or less than the bit error rate reference value E2, if the bit error rate obtained in S2 is E2 (See FIGS. 5 and 6). Therefore, the controller 30 maintains the track margin management information 33 in a state as illustrated in FIG. 7. As a result, the value of the track margin is maintained at TM0×K2.

When there are other unselected test targets (Yes in S6), the controller 30 selects one test target from the unselected test targets, and the process returns to S2.

When there is no other unselected test target (No in S6), the controller 30 finishes the process.

As described above, according to the embodiment, in the disk device 1, the controller 30 updates the track margin management information, according to the bit error rate reference value and the bit error rate of information read from a track. This configuration makes it possible to improve the accuracy in prediction of the correction limit, thus, suppressing occurrence of read error.

Note that, as a first modification of the embodiment, the track margin may be managed for each zone in which multiple tracks in the disk medium 11 are grouped, in addition to being managed for each head 22.

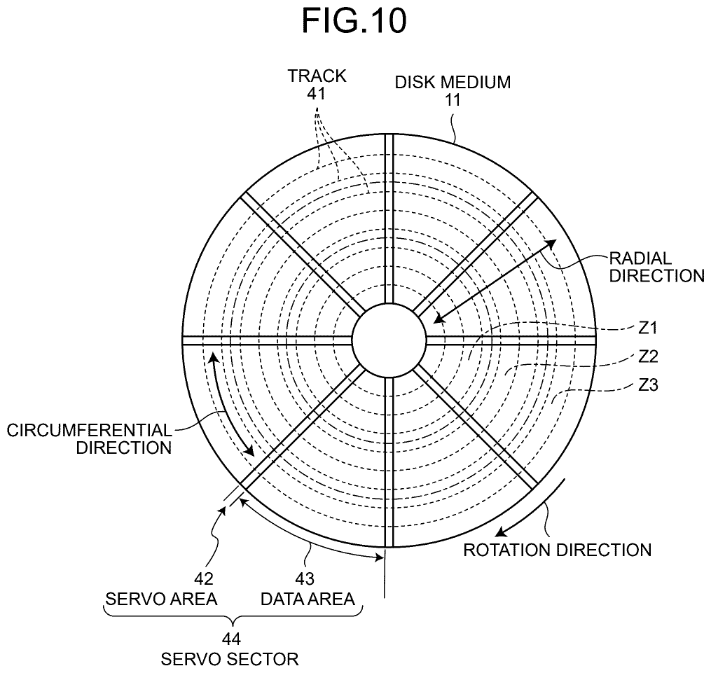

For example, the multiple tracks 41 in each disk medium 11 may be grouped into multiple zones Z1 to Z3 as illustrated in FIG. 10. FIG. 10 is a diagram illustrating a configuration of the disk medium 11 according to the first modification of the embodiment.

The multiple zones Z1 to Z3 is concentrically arranged from an inner peripheral side to an outer peripheral side. The zones Z each include two or more tracks 41. In FIG. 10, of eight tracks 41, three tracks 41 on the inner peripheral side are included in the zone Z1, three tracks 41 in a mid-periphery are included in the zone Z2, and two tracks 41 on the outer peripheral side are included in the zone Z3. The number of tracks included in each zone Z may be the same, or there may be zones in which the number of tracks is different between the zones. The number of tracks in the disk medium 11 may be larger than the number of tracks illustrated in FIG. 10, and the number of tracks included in each zone Z may be larger than the number of tracks illustrated in FIG. 10.

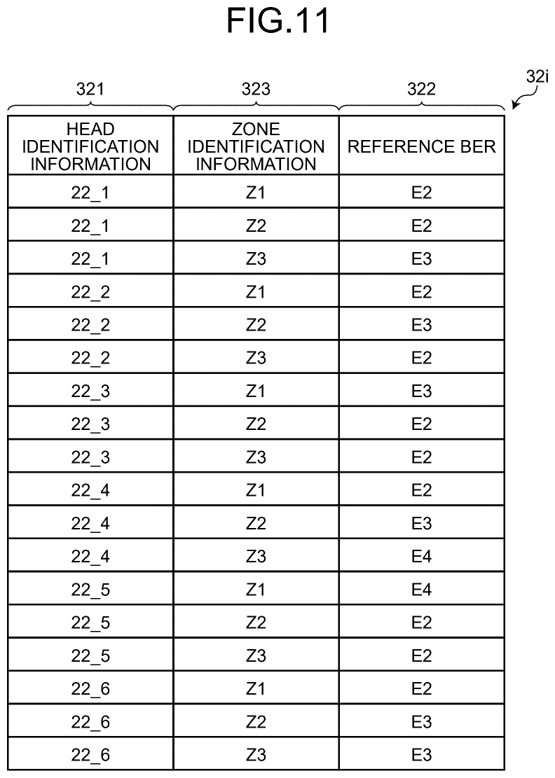

In this configuration, the bit error rate reference value may also be managed for each zone Z, in addition to being managed for each head 22. The controller 30 may have reference bit error rate management information 32i as illustrated in FIG. 11. FIG. 11 is a table illustrating a configuration of the reference bit error rate management information 32i according to the first modification of the embodiment.

In the reference bit error rate management information 32i, the identification information of each head 22, the identification information of each zone Z, and the bit error rate reference value are associated with each other, for the multiple heads 22 and the multiple zones Z1 to Z3. The reference bit error rate management information 32i may be implemented in the form of a table as illustrated in FIG. 11. The reference bit error rate management information 32i includes a head identification information column 321, a zone identification information column 323, and a reference BER column 322. In the head identification information column 321, identification information for the respective heads 22 is recorded. In the zone identification information column 323, identification information of the respective zones Z is recorded. In the reference BER column 322, the bit error rate reference values are recorded. In the reference BER column 322, the bit error rate reference values may be recorded that are acquired upon testing before shipment of the disk device 1.

Referring to the reference bit error rate management information 32i makes it possible to identify the bit error rate reference value corresponding to the identification information for each head 22. For example, with reference to the reference bit error rate management information 32i, the bit error rate reference value of the zone “Z1” of the head “22_1” is identified as “E2”. The bit error rate reference value of the head “22_1” in the zone “Z2” is identified as “E2”. The bit error rate reference value of the head “22_1” in the zone “Z3” is identified as “E3”. The bit error rate reference value of the head “22_6” in the zone “Z1” is identified as “E2”. The bit error rate reference value of the head “22_6” in the zone “Z2” is identified as “E3”. The bit error rate reference value of the head “22_6” in the zone “Z3” is identified as “E3”.

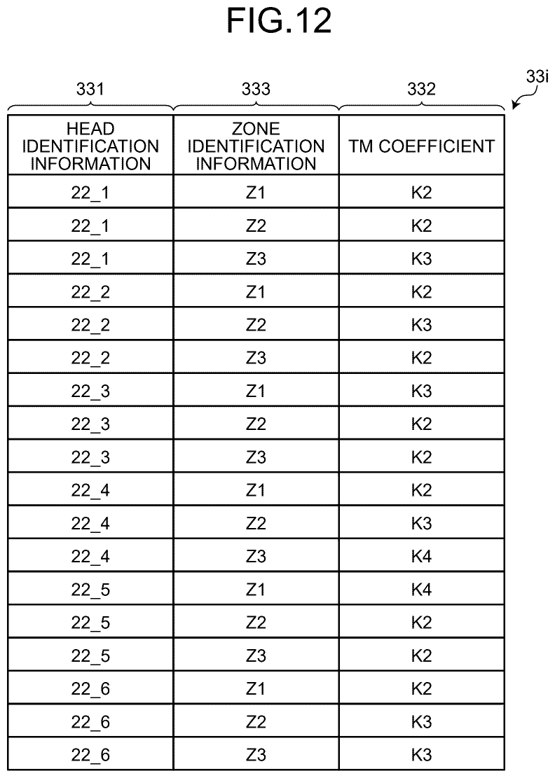

The controller 30 may create track margin management information 33i as illustrated in FIG. 12, according to the update management information 31 as illustrated in FIG. 5 and the reference bit error rate management information 32i as illustrated in FIG. 11. FIG. 12 is a table illustrating a configuration of the track margin management information 33i (before update) according to the first modification of the embodiment.

In the track margin management information 33i, the identification information of each head 22, the identification information of each zone Z, and the track margin are associated with each other, for the multiple heads 22. The track margin management information 33i may be implemented in the form of a table as illustrated in FIG. 12. The track margin management information 33i includes the head identification information column 331, a zone identification information column 333, and the TM coefficient column 332. In the head identification information column 331, identification information for the respective heads 22 is recorded. In the zone identification information column 333, identification information of the respective zone Z is recorded. In the TM coefficient column 332, values of the track margin coefficient are recorded. In the TM coefficient column 332, the values of the track margin coefficient may be recorded that are determined according to the update management information 31 as illustrated in FIG. 5 and the reference bit error rate management information 32i as illustrated in FIG. 12, upon testing before shipment of the disk device 1.

For example, according to the reference bit error rate management information 32i, the bit error rate reference value of the head “22_1” in the zone “Z1” is “E2”, and according to the update management information 31, when the bit error rate is “E2”, the appropriate track margin coefficient is “K2”. Therefore, in the track margin management information 33i, “K2” is registered as the value of the track margin coefficient of the head “22_1” in the zone “Z1”.

According to the reference bit error rate management information 32i, the bit error rate reference value of the head “22_1” in the zone “Z2” is “E2”, and according to the update management information 31, when the bit error rate is “E2”, the appropriate track margin coefficient is “K2”. Therefore, in the track margin management information 33i, “K2” is registered as the value of the track margin coefficient of the head “22_1” in the zone “Z2”.

According to the reference bit error rate management information 32i, the bit error rate reference value of the head “22_1” in the zone “Z3” is “E3”, and according to the update management information 31, when the bit error rate “E3”, the appropriate track margin coefficient is “K3”. Therefore, in the track margin management information 33i, “K3” is registered as the value of the track margin coefficient of the head “22_1” in the zone “Z3”.

According to the reference bit error rate management information 32i, the bit error rate reference value of the head “22_6” in the zone “Z1” is “E2”, and according to the update management information 31, when the bit error rate is “E2”, the appropriate track margin coefficient is “K2”. Therefore, in the track margin management information 33i, “K2” is registered as the value of the track margin coefficient of the head “22_6” in the zone “Z1”.

According to the reference bit error rate management information 32i, the bit error rate reference value of the head “22_6” in the zone “Z2” is “E3”, and according to the update management information 31, when the bit error rate is “E3”, the appropriate track margin coefficient is “K3”. Therefore, in the track margin management information 33i, “K3” is registered as the value of the track margin coefficient of the head “22_6” in the zone “Z2”.

According to the reference bit error rate management information 32i, the bit error rate reference value of the head “22_6” in the zone “Z3” is “E3”, and according to the update management information 31, when the bit error rate is “E3”, the appropriate track margin coefficient is “K3”. Therefore, in the track margin management information 33i, “K3” is registered as the value of the track margin coefficient of the head “22_6” in the zone “Z3”.

After shipment of the disk device 1, the controller 30 may perform a bit error rate testing process as illustrated in FIG. 8.

After S1 to S3 are performed similarly to the embodiment, when the bit error rate obtained in S2 exceeds the bit error rate reference value (Yes in S3), the controller 30 determines that the bit error rate degrades, and updates the track margin of the head 22 to be tested (S4).

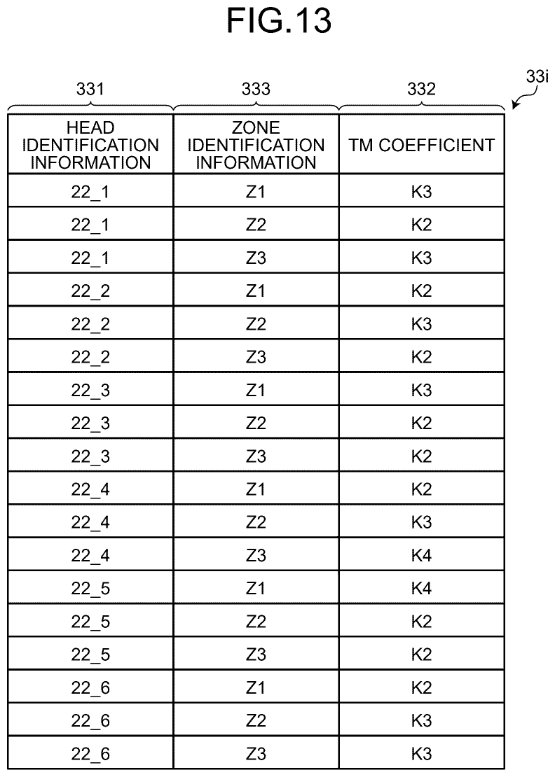

For example, when the head 22 to be tested is the head 22_1 and a zone Z to be tested is the zone Z1, the bit error rate E3 exceeds the bit error rate reference value E2, if the bit error rate obtained in S2 is E3 (See FIGS. 5 and 11). Therefore, the controller 30 refers to the update management information 31 and identifies the track margin coefficient K3 corresponding to the bit error rate E3. The controller 30 accesses the track margin management information 33i as illustrated in FIG. 12 and updates the value of the TM coefficient column 332 corresponding to the head 22_1 and the zone Z1 to “K3” by overwriting, as illustrated in FIG. 13. FIG. 13 is a table illustrating a configuration of the track margin management information 33i (after update) according to the first modification of the embodiment. As a result, the value of the track margin is updated from TM0×K2 to the stricter value TM0×K3.

Thereafter, S5 to S6 are performed similarly to the embodiment.

In the disk device 1 configured as above, the controller 30 updates the track margin management information, according to the bit error rate reference value and the bit error rate of information read from a track. This configuration makes it possible to improve the accuracy in prediction of the correction limit, thus, suppressing occurrence of read error.

Alternatively, as a second modification of the embodiment, a correction limit prediction process in consideration of the bit error rate testing process may be performed.

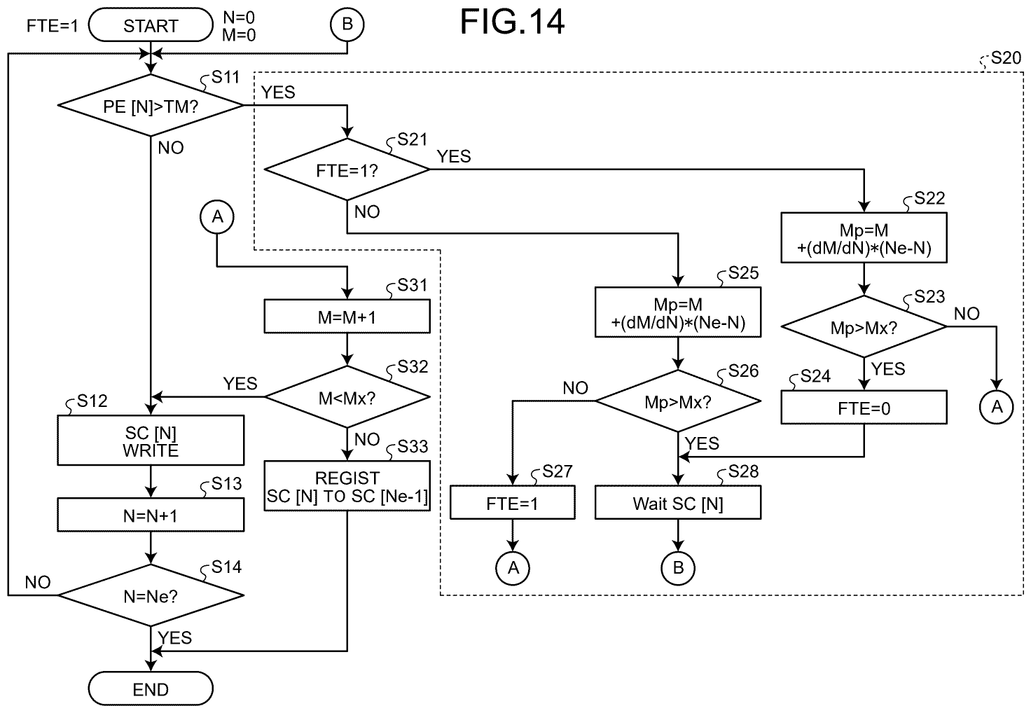

For example, the disk device 1 may perform an operation as illustrated in FIG. 14 in parallel with the bit error rate testing process illustrated in FIG. 8. FIG. 14 is a flowchart illustrating an operation of the disk device 1 according to the second modification of the embodiment; and

In the disk device 1, in starting writing of a track TR_k (k is any integer of 1 or more), the controller 30 performs initialization so that a track ECC valid flag FTE=1, the number N of write sectors on the track TR_k=0, and the number M of sectors determined to be damaged on the track TR_k=0.

Note that a value of the track ECC valid flag FTE of 1 indicates that an operation mode of the disk device 1 is a track ECC valid mode. When a value of the track ECC valid flag FTE of 0 indicates that the operation mode of the disk device 1 is a track ECC invalid mode.

When a positioning error PE [N] in the number N of write sectors on the track TR_k does not exceed a track margin TM (No in S11), the controller 30 writes the sector SC [N] (S12). The controller 30 increments the number N of write sectors (S13).

The controller 30 repeats a loop of S11 to S14 until the number N of write sectors is equal to a total number Ne of sectors (No in S14). When the number N of write sectors is equal to the total number Ne of sectors (Yes in S14), the controller 30 determines that the writing of the total number Ne of sectors has been completed, and finishes the process.

When the positioning error PE [N] in the number N of write sectors on the track TR_k exceeds the track margin TM (Yes in S11), the controller 30 performs a track ECC mode control process (S20).

In the track ECC mode control process (S20), during the track ECC valid mode (Yes in S21), the controller 30 predicts the number Mp of sectors determined to be damaged at the end of writing the total number Ne of sectors, from a change rate dM/dN in the number M of sectors determined to be damaged with respect to the number N of write sectors, the number of remaining sectors (Ne−N), and the number M of sectors determined to be damaged (S22). When the number Mp of sectors determined to be damaged does not reach correction limit Mx in the number of sectors (No in S23), the controller 30 exits the track ECC mode control process (S20).

The controller 30 after exit of S20 via S23 increments the number M of sectors determined to be damaged (S31), and writes the sector SC [N] (S12), when the number M of sectors determined to be damaged does not reach the correction limit Mx in the number of sectors (Yes in S32).

When the number M of sectors determined to be damaged reaches the correction limit Mx in the number of sectors (No in S32), the controller 30 registers the remaining sectors SC [N] to SC [Ne−1] before completion of writing, as replacement information or writes the remaining sectors SC [N] to SC [Ne−1] to the replacement area (S33).

In the track ECC mode control process (S20), when the number Mp of sectors determined to be damaged reaches the correction limit Mx in the number of sectors (Yes in S23), the controller 30 sets the track ECC valid flag FTE=0 and shifts the operation mode to the track ECC invalid mode (S24). The controller 30 proceeds to write retry processing, waits for rotation for writing the sector SC [N] to another track (S28), and performs the processing in and after S11 for another track TR_k+1.

In the track ECC mode control process (S20), during the track ECC invalid mode (No in S21), the controller 30 predicts the number Mp of sectors determined to be damaged at the end of writing the total number Ne of sectors, from the change rate dM/dN in the number M of sectors determined to be damaged with respect to the number N of write sectors, the number of remaining sectors (Ne−N), and the number M of sectors determined to be damaged (S25).

At this time, this prediction is performed in parallel with the bit error rate testing process (see FIG. 8), and there is a possibility that the state of the disk device 1 may change due to the update of the track margin.

Therefore, when the number Mp of sectors determined to be damaged is smaller than the correction limit Mx in the number of sectors during the track ECC invalid mode (No in S26), the controller 30 sets the track ECC valid flag FTE=1, returns the operation mode to the track ECC valid mode (S27), and performs the processing in and after S31.

In the track ECC mode control process (S20), when the number Mp of sectors determined to be damaged reaches the correction limit Mx in the number of sectors during the track ECC invalid mode (Yes in S26), the controller 30 maintains the track ECC valid flag FTE=0, proceeds to the write retry processing, waits for rotation for writing the sector SC [N] to another track (S28), and performs the processing in and after S11 for the another track TR_k+1.

In this manner, the correction limit prediction process can be performed by dynamically adapting to the update of the track margin management information, in consideration of the bit error rate testing process. Therefore, the accuracy in prediction of the correction limit can be further improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a head;
a disk medium having a recording surface configured to face the head, the disk medium being medium where multiple tracks defined on the recording surface, each of the multiple tracks including multiple sectors; and
a controller configured to:
perform error correction for each of the sectors on a per track basis;
predict, while writing data to a first track of the multiple tracks by the head, that the number of error sectors of a second track adjacent to the first track reaches a correction limit number of sectors, according to a track margin identified by first management information and an off-track amount of the first track; and
update the first management information according to a bit error rate reference value and a bit error rate of information read from a track.

2. The disk device according to claim 1, wherein
the controller updates the first management information, when the bit error rate of the information read from the track exceeds the reference value.

3. The disk device according to claim 2, wherein
when the bit error rate of the information read from the track is equal to or less than the reference value, the controller maintains the first management information.

4. The disk device according to claim 1, wherein
the disk device includes:
multiple heads; and
multiple disk media that corresponds to the multiple heads, and each of which includes a recording surface configured to face the corresponding head, and multiple tracks being defined on the recording surface and each including multiple sectors,
wherein in the first management information, head identification information and track margin information are associated with each other for the multiple heads, and
the controller updates, for each of the multiple heads, the first management information according to a bit error rate reference value and a bit error rate of information read from a track.

5. The disk device according to claim 4, wherein
the controller updates the first management information, for each of the multiple heads, when a bit error rate of information read from a track exceeds the reference value.

6. The disk device according to claim 5, wherein
the controller maintains the first management information for each of the multiple heads, when a bit error rate of information read from a track is equal to or less than the reference value.

7. The disk device according to claim 4, wherein
the controller updates, for each of the multiple heads, the first management information according to a bit error rate reference value and a bit error rate of information read from a track, the bit error rate reference value being identified by second management information, the second management information being information where head identification information and a bit error rate reference value are associated with each other for the multiple heads.

8. The disk device according to claim 1, wherein
the controller updates the first management information by using track margin information, the track margin information being determined according to third management information and a bit error rate of information read from a track, the third management information being information where a bit error rate and track margin information being associated with each other for multiple bit error rates.

9. The disk device according to claim 8, wherein
the controller updates the first management information by using the determined track margin information, when a bit error rate of information read from a track exceeds the reference value.

10. The disk device according to claim 4, wherein
the controller updates, for each of the multiple heads, the first management information by using track margin information determined according to third management information and a bit error rate of information read from a track, the third management information being information where a bit error rate and track margin information being associated with each other for multiple bit error rates.

11. The disk device according to claim 10, wherein
the controller updates, for each of the multiple heads, the first management information by using the determined track margin information, when a bit error rate of information read from a track exceeds the reference value.

12. The disk device according to claim 11, wherein
the controller updates, for each of the multiple heads, the first management information by updating track margin information corresponding to the head identification information to the determined track margin information by overwriting, when a bit error rate of information read from a track exceeds the reference value.

13. The disk device according to claim 4, wherein
the multiple tracks in each disk medium are grouped into multiple zones each including two or more tracks,
the first management information being information where head identification information, zone identification information, and track margin information are associated with each other, for the multiple heads and the multiple zones, and
the controller updates the first management information according to a bit error rate reference value and a bit error rate of information read from a track, for each of the multiple heads and each of the multiple zones.

14. The disk device according to claim 13, wherein
the controller updates the first management information, for each of the multiple heads and each of the multiple zones, when a bit error rate of information read from a track exceeds the reference value.

15. The disk device according to claim 14, wherein
the controller maintains the first management information, for each of the multiple heads and each of the multiple zones, when a bit error rate of information read from a track is equal to or less than the reference value.

16. The disk device according to claim 13, wherein
the controller updates, for each of the multiple heads and each of the multiple zones, the first management information by using track margin information determined according to third management information and a bit error rate of information read from a track, the third management information being information where a bit error rate and track margin information being associated with each other for multiple bit error rates.

17. The disk device according to claim 16, wherein
the controller updates, for each of the multiple heads and each of the multiple zones, the first management information by using the determined track margin information, when a bit error rate of information read from a track exceeds the reference value.

18. The disk device according to claim 17, wherein
the controller updates, for each of the multiple heads and each of the multiple zones, the first management information by updating track margin information corresponding to the head identification information and the zone identification information to the determined track margin information by overwriting, when a bit error rate of information read from a track exceeds the reference value.

19. The disk device according to claim 13, wherein
the controller updates, for each of the multiple heads and each of the multiple zones, the first management information according to a bit error rate reference value and a bit error rate of information read from a track, the bit error rate reference value being identified by the second management information, the second management information being information where head identification information, zone identification information, and a bit error rate reference value are associated with each other for the multiple heads and the multiple zones.

20. The disk device according to claim 19, wherein
the controller updates, for each of the multiple heads and each of the multiple zones, the first management information by using track margin information determined according to third management information and a bit error rate of information read from a track, the third management information being information where a bit error rate and track margin information are associated with each other for multiple bit error rates.
